(19) United States
(12) Patent Application Publication
(10) Pub. No.: US 2024/0372309 A1
(43) Pub. Date: Nov. 7, 2024

(54) GAIN-FLATTENING FIBER BRAGG GRATING WRITTEN INTO GAIN MEDIA OF OPTICAL AMPLIFIER SYSTEM

(71) Applicant: Lumentum Operations LLC, San Jose, CA (US)

(72) Inventor: Josh P. KEMP, Kanata (CA)

(21) Appl. No.: 18/451,318

(22) Filed: Aug. 17, 2023

Related U.S. Application Data
(60) Provisional application No. 63/500,162, filed on May 4, 2023.

(51) Int. Cl. H01S 3/067; H01S 3/094

(52) U.S. Cl. CPC H01S 3/0675; H01S 3/06758; H01S 3/094003

(57) ABSTRACT

An optical amplifier assembly includes an optical amplifier stage including an active fiber with an active fiber core configured to guide and amplify a signal light; a pump laser configured to provide pump laser light; a wavelength-division multiplexing (WDM) coupler configured to couple the pump laser light into the active fiber core; and a gain-flattening fiber Bragg grating (FBG) arranged in the active fiber core. The optical amplifier stage is configured to provide a spectral gain profile corresponding to the active fiber core and the pump laser. The gain-flattening FBG is configured to at least partially flatten the spectral gain profile in order for the optical amplifier assembly to provide an amplified signal light with an at least partially flattened first spectral gain profile. The amplified signal light is derived from the signal light propagating through the active fiber core.

### CROSS-REFERENCE TO RELATED APPLICATION

This Patent Application claims priority to U.S. Patent Application No. 63/500,162, filed on May 4, 2023, and entitled “ERBIUM DOPED AMPLIFIER GAIN-FLATTENED USING FIBER BRAGG GRATING WRITTEN IN GAIN MEDIA.” The disclosure of the prior Application is considered part of and is incorporated by reference into this Patent Application.

### TECHNICAL FIELD

The present disclosure relates generally to an optical amplifier assembly that includes one or more optical amplifier stages and one or more gain-flattening fiber Bragg gratings (FBGs).

### BACKGROUND

An optical amplifier is a device that is to receive signal light and generate amplified signal light (i.e., signal light with comparatively higher optical power). Typically, the optical amplifier provides optical amplification using a so-called gain medium, which is “pumped” (i.e., provided with energy) by a source, such as a pump laser. In some cases, the optical amplifier may utilize an optical fiber as a gain medium (such a device may be referred to as a fiber amplifier). In such a case, the gain medium may be a glass fiber doped with rare earth ions, such as erbium, neodymium, ytterbium, praseodymium, thulium, or the like. Such a fiber may be referred to as an active fiber. In operation, the signal light propagates through an active core of the active fiber together with pump light, and the active fiber outputs the amplified signal light that is generated from the signal light and the pump light. Generally, such optical amplifiers include other discrete components associated with controlling, enabling, and/or monitoring optical amplification. Such discrete components may include, for example, one or more isolators, a pump combiner (e.g., a wavelength-division multiplexer (WDM)), a tunable filter, a variable optical attenuator (VOA), a gain-flattening filter (GFF), a tap, a photo diode, or the like.

### SUMMARY

In some implementations, an optical amplifier assembly includes a first optical amplifier stage comprising: a first active fiber with a first active fiber core configured to guide and amplify a first signal light; a first pump laser configured to provide first pump laser light; a first wavelength-division multiplexing (WDM) coupler configured to couple the first pump laser light into the first active fiber core; and a first gain-flattening fiber Bragg grating (FBG) arranged in the first active fiber core, wherein the first optical amplifier stage is configured to provide a first spectral gain profile corresponding to the first active fiber core and the first pump laser, wherein the first gain-flattening FBG is configured to at least partially flatten the first spectral gain profile in order for the optical amplifier assembly to provide a first amplified signal light with an at least partially flattened first spectral gain profile, and wherein the first amplified signal light is derived from the first signal light propagating through the first active fiber core.

In some implementations, an optical amplifier assembly includes an optical amplifier stage comprising: an active fiber with an active fiber core configured to guide and amplify a signal light; a pump laser configured to provide pump laser light; and a WDM coupler configured to couple the pump laser light into the active fiber core; an optical component coupled to the optical amplifier stage; an integral input pigtail integrated with an input of the optical component, wherein the integral input pigtail is a first single-mode fiber with a first single-mode fiber core; and an integral output pigtail integrated with an output of the optical component, wherein the integral output pigtail is a second single-mode fiber with a second single-mode fiber core, wherein the integral input pigtail, the optical component, and the integral output pigtail form a continuous signal path devoid of any splices, wherein the active fiber core, the first single-mode fiber core, and second single-mode fiber core form a light propagation path, wherein the optical component comprises a gain-flattening FBG arranged in the first single-mode fiber core or in the second single-mode fiber core, wherein the optical amplifier stage is configured to provide a spectral gain profile corresponding to the active fiber core and the pump laser, wherein the gain-flattening FBG is configured to at least partially flatten the spectral gain profile in order for the optical amplifier assembly to provide an amplified signal light with an at least partially flattened spectral gain profile, and wherein the amplified signal light is derived from the signal light propagating through the active fiber core.

In some implementations, a method of writing a gain-flattening FBG into an active optical fiber of an optical amplifier assembly includes measuring the spectral gain profile of the optical amplifier assembly to determine the spectral gain profile; and writing the gain-flattening FBG into the active fiber core, wherein the gain-flattening FBG is written into the active fiber core to provide a gain-flattening function that compensates for the spectral gain profile such that the gain-flattening FBG at least partially flattens the spectral gain profile in order to achieve a desired gain-flattened spectral profile within a predetermined margin.

In some implementations, a method of writing a gain-flattening FBG into an optical amplifier assembly includes coupling a pump laser to an active optical fiber, wherein the active optical fiber includes an active fiber core configured as a gain medium that contributes to a spectral gain profile of the optical amplifier assembly; coupling the active optical fiber to a single-mode fiber, wherein the single-mode fiber includes a single-mode core that forms a propagation path with the active fiber core for signal light; subsequent to coupling the pump laser to the active optical fiber and subsequent to coupling the active optical fiber to the single-mode fiber, measuring the spectral gain profile of the optical amplifier assembly to determine the spectral gain profile; and subsequent to measuring the spectral gain profile, writing the gain-flattening FBG into the active fiber core or into the single-mode core using a laser, wherein the gain-flattening FBG is written into the active fiber core or into the single-mode core to provide a gain-flattening function that compensates for the spectral gain profile such that the gain-flattening FBG at least partially flattens the spectral gain profile in order to achieve a desired gain-flattened spectral profile.

### BRIEF DESCRIPTION OF THE DRAWINGS

FIG. 1 shows an optical amplifier assembly according to one or more implementations.

FIG. 2 shows an optical amplifier assembly according to one or more implementations.

FIG. 3A shows an optical amplifier assembly according to one or more implementations.

FIG. 3B shows an optical amplifier assembly according to one or more implementations.

FIG. 4A shows an optical amplifier assembly according to one or more implementations.

FIG. 4B shows an optical amplifier assembly according to one or more implementations.

FIG. 5 shows an optical amplifier assembly according to one or more implementations.

FIG. 6 shows a system for writing a gain-flattening FBG into an optical fiber of an optical amplifier assembly according to one or more implementations.

FIG. 7 is a flowchart of an example process associated with a method of writing a gain-flattening FBG into an active optical fiber of an optical amplifier assembly.

FIG. 8 is a flowchart of an example process associated with a method of writing a gain-flattening FBG into an optical amplifier assembly.

FIG. 9 shows an optical amplifier assembly according to one or more implementations.

### DETAILED DESCRIPTION

The following detailed description of example implementations refers to the accompanying drawings. The same reference numbers in different drawings may identify the same or similar elements.

Optical amplifiers may include a GFF that is used to create uniform gain over a broad wavelength range. For example, the GFF may be coupled to an output of an active fiber of the optical amplifier. The GFF may be used to flatten the gain of the optical amplifier. For example, the GFF may be configured to process an optical signal output from the active fiber to provide gain-flattening. However, the GFF is a costly element in a bill of materials of an optical amplifier. For example, the GFF is an additional optical component separate from other optical components that may be included in the optical amplifier, such as an active fiber, a WDM, a photodiode, a VOA, and an optical isolator. Thus, manufacturing the GFF requires additional cost in material for manufacturing the GFF, as well as additional processes separate from the manufacturing of the other optical components. Moreover, additional process steps are needed to couple the GFF into the optical amplifier. As a result, implementing the GFF in the optical amplifier increases complexity and overall manufacturing and assembly costs for the optical amplifier.

Some implementations are directed to replacing a gain-flattening function of a GFF by writing an FBG having a gain-flattening function into an active core of an active fiber and/or integrating the FBG into another optical component of an optical amplifier assembly, such as a WDM, a photodiode, a VOA, and/or an optical isolator. For example, the FBG having the gain-flattening function (i.e., a gain-flattening FBG) can be written into the active core of the active fiber of an optical amplifier stage of the optical amplifier assembly or can be written into a core of an integral fiber of another optical component. The integral fiber may be a single-mode fiber that is integrated with the optical component. For example, the integral fiber may be a pigtail of the optical component.

Historically, creating an FBG required a specially doped fiber that is activated with ultraviolet (UV) light. However, according to one or more implementations, a femtosecond laser may be used to create the gain-flattening FBG in any fiber of the optical amplifier assembly without modifying a composition of the fiber. Additionally, the gain-flattening FBG can be written into any fiber of the optical amplifier assembly without stripping the fiber coating. Thus, the gain-flattening function can be integrated into the optical amplifier assembly in a more cost-effective way than using a GFF. In some implementations, a gain-flattening FBG may be fabricated by assembling the optical amplifier assembly, measuring a gain variation of the assembled optical amplifier assembly, and then writing the gain-flattening FBG into a fiber of the optical amplifier assembly such that the FBG spectrum compensates for the gain variation (e.g., provides an ideal gain-flattening function).

Thus, the gain-flattening FBG may be written with a specific gain-flattening function to achieve a desired result (e.g., a desired gain-flattening based on a spectral gain profile of the optical amplifier assembly). In other words, patterning the gain-flattening FBG by the femtosecond laser can be adjusted to achieve the desired gain-flattening function without adding any additional cost in materials to the optical amplifier assembly. In contrast, different types of GFFs may need to be manufactured to achieve different gain-flattening functions, which may increase manufacturing costs (e.g., material costs) in order to manufacture the different types of GFFs. Thus, removal of the GFF from a design of an optical amplifier assembly may be achieved to reduce cost in the bill of materials. In addition, writing the gain-flattening FBG into the optical amplifier assembly may provide additional options for achieving gain-flattening to improve performance without adding cost in materials.

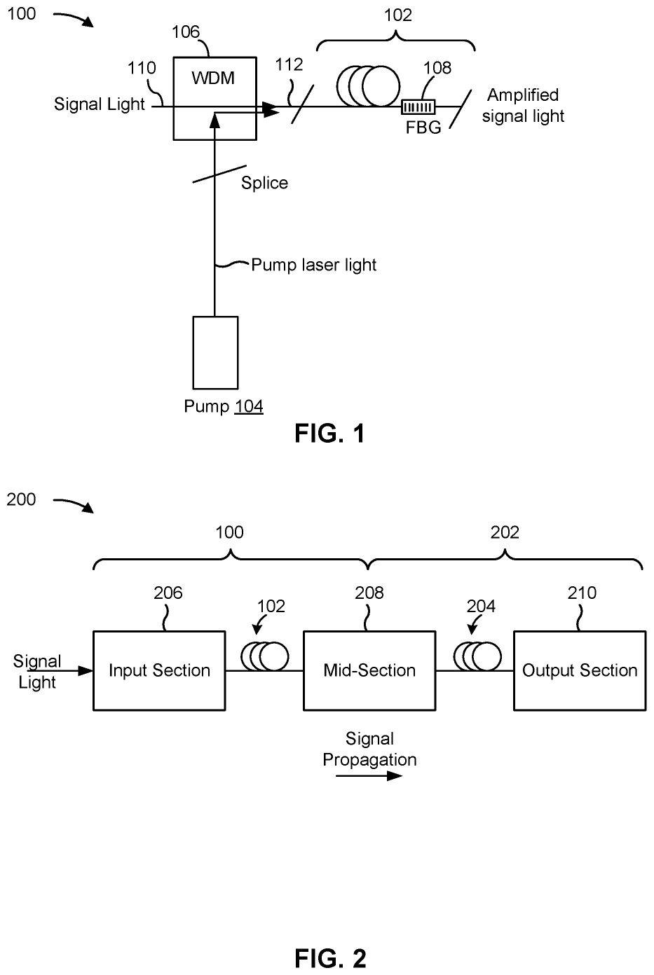

FIG. 1 shows an optical amplifier assembly 100 according to one or more implementations. The optical amplifier assembly 100, as shown, is an optical amplifier stage (e.g., a first optical amplifier stage). While not shown in FIG. 1, the optical amplifier assembly 100 may include multiple optical amplifier stages.

The optical amplifier stage may include an active fiber 102, a pump laser 104, a WDM coupler 106, and a gain-flattening FBG 108. Optical fibers of the active fiber 102, the pump laser 104, and the WDM coupler 106 may be coupled together via splices indicated by slashes (“/”).

The active fiber 102 includes an active fiber core that is configured to guide and amplify a signal light. The pump laser 104 is configured to provide a pump laser light. The WDM coupler 106 may include an input fiber 110 (e.g., an integral input pigtail) that receives the signal light and an output fiber 112 (e.g., an integral output pigtail). The input fiber 110 and the output fiber 112 may be single-mode fibers, each with a single-mode fiber core. The signal light may be a group of wavelength-multiplexed optical signals carrying data. The WDM coupler 106 is configured to receive the signal light and the pump laser light, and couple the signal light and the pump laser light into a fiber core of the output fiber 112. The fiber core of the output fiber 112 may be coupled to the active fiber core of the active fiber 102. Thus, the WDM coupler 106 is configured to couple the signal light and the pump laser light into the active fiber core of the active fiber 102. In other words, the WDM coupler 106 adds the pump laser light to the active fiber core of the active fiber 102, along with the signal light. The active fiber 102 may use the pump laser light to amplify the signal light in the active fiber core.

In this example, the WDM coupler 106 is arranged at an input section of the optical amplifier assembly 100. The input section may also include one or more tap couplers (e.g., a tap coupler coupled to a photodiode) or isolators. A tap coupler or an isolator may each have a respective integral input pigtail and/or a respective integral output pigtail that is integrated with the tap coupler or the isolator. Here, “integrated” means coupled to (e.g., using lens coupling or other free space means) or fused (e.g., a fused fiber component) without a use of a splice (e.g., a fusion spice). The respective integral input pigtail and the respective integral output pigtail may be single-mode fibers, each with a single-mode fiber core that is coupled directly or indirectly to the active fiber core of the active fiber 102.

An output of the active fiber 102 may be coupled to an output section of the optical amplifier assembly 100, which is not explicitly shown in this example. The output section may include one or more optical components configured to receive amplified signal light from the active fiber 102. The one or more optical components may include one or more tap couplers, one or more isolators, one or more WDMs, and/or one or more VOAs. Each optical component may have a respective integral input pigtail and/or a respective integral output pigtail that is integrated with the optical component. The respective integral input pigtail and the respective integral output pigtail may be single-mode fibers, each with a single-mode fiber core that is coupled directly or indirectly to the active fiber core of the active fiber 102.

The gain-flattening FBG 108 is arranged in the active fiber core of the active fiber 102. For example, the gain-flattening FBG 108 may be written into the active fiber core using a femtosecond laser. The active fiber 102 is a single continuous fiber, and the active fiber core is a single continuous fiber core into which the gain-flattening FBG 108 is written. The optical amplifier assembly 100 (e.g., the optical amplifier stage) is configured to provide a spectral gain profile corresponding to the active fiber core of the active fiber 102 and the pump laser 104. In other words, both the active fiber core of the active fiber 102 and the pump laser 104 contribute to the spectral gain profile. This is the spectral gain profile that would be provided in the absence of the gain flattening FBG 108. The gain-flattening FBG 108 is configured to at least partially flatten the spectral gain profile in order for the optical amplifier assembly 100 (e.g., the optical amplifier stage) to provide an amplified signal light with an at least partially flattened spectral gain profile. The amplified signal light is derived from the signal light propagating through the active fiber core of the active fiber 102. Thus, the signal light, amplified signal light, or partially amplified signal light may pass through the gain-flattening FBG 108, and the gain-flattening FBG 108 may perform a gain-flattening function on the signal light, the amplified signal light, or the partially amplified signal light passing through the gain-flattening FBG 108 to compensate for the spectral gain profile.

The gain-flattening FBG 108 may be configured to provide the amplified signal light with the at least partially flattened spectral gain profile. For example, the gain-flattening FBG 108 may be arranged at an output portion of the active fiber core of the active fiber 102. However, the gain-flattening FBG 108 may be arranged anywhere in the active fiber core of the active fiber 102.

The gain-flattening FBG 108 may be configured to substantially or completely flatten the spectral gain profile in order for the optical amplifier assembly 100 to provide the amplified signal light with the at least partially flattened spectral gain profile. For example, the gain-flattening FBG 108 may be configured to perform a gain-flattening function that is matched or substantially matched with the spectral gain profile within a predetermined margin in order for the optical amplifier assembly 100 to provide the amplified signal light with the at least partially flattened spectral gain profile. For example, the gain-flattening function may be used to achieve a flattened spectral gain profile that is within a predetermined margin from a desired flattened spectral gain profile (e.g., within 10% from the desired flattened spectral gain profile across the gain spectrum). In some implementations, the flattened spectral gain profile may be within 1.0 dB of the desired flattened spectral gain profile across the gain spectrum (e.g., equal to or less than 1.0 dB of the desired flattened spectral gain profile across the gain spectrum). In some implementations, the flattened spectral gain profile may be within 0.5 dB of the desired flattened spectral gain profile across the gain spectrum (e.g., equal to or less than 0.5 dB of the desired flattened spectral gain profile across the gain spectrum). Thus, the gain-flattening FBG 108 may be configured to perform the gain-flattening function that compensates for the spectral gain profile such that the gain-flattening FBG 108 at least partially flattens the spectral gain profile in order to achieve the at least partially flattened spectral gain profile.

As indicated above, FIG. 1 is provided as an example. Other examples may differ from what is described with regard to FIG. 1. The number and arrangement of devices and components shown in FIG. 1 are provided as an example. In practice, there may be additional devices or components, fewer devices or components, different devices or components, or differently arranged devices or components than those shown in FIG. 1.

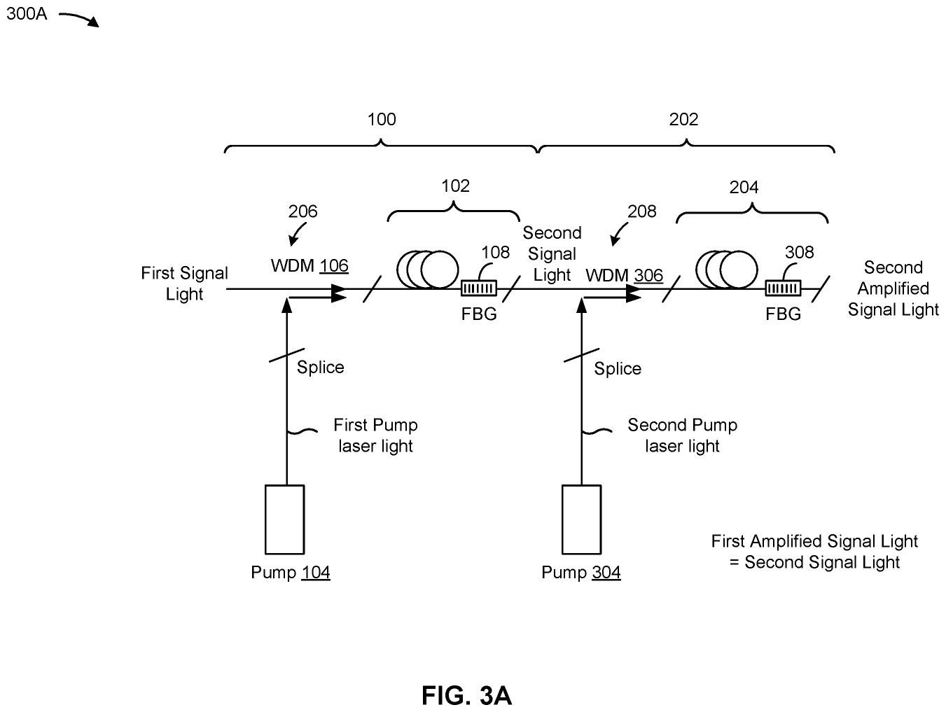

FIG. 2 shows an optical amplifier assembly 200 according to one or more implementations. The optical amplifier assembly 200 may include multiple optical amplifier stages, with each optical amplifier stage having a respective active fiber. For example, the optical amplifier assembly 200 may incorporate the optical amplifier assembly 100 described in connection with FIG. 1 as a first optical amplifier stage or as a second optical amplifier stage. In this example, the optical amplifier assembly 100, including the active fiber 102 (e.g., a first active fiber 102), is used as the first optical amplifier stage of the optical amplifier assembly 200. The optical amplifier assembly 200 further includes a second optical amplifier stage 202 coupled to the first optical amplifier stage 100. The second optical amplifier stage 202 includes a second active fiber 204 that has a second active fiber core configured to guide and amplify a second signal light. The second active fiber core is coupled to the first active fiber core. For example, the second active fiber core is coupled to an output of the first active fiber core. In this example, the first optical amplifier stage 100 may be configured to provide the amplified signal light described in connection with FIG. 1 (e.g., a first amplified signal light) as the second signal light to the second optical amplifier stage 202. Thus, the second signal light may be derived from the first amplified signal light. The second active fiber core may be directly coupled to the first active fiber core. Alternatively, other optical components may be inserted between the first and second active fiber cores.

The optical amplifier assembly 200 may include an input section 206 coupled to an input of the first active fiber 102, a mid-section 208 coupled to and between the first active fiber 102 and the second active fiber 204, and an output section 210 coupled to an output of the second active fiber 204. The input section 206 may be part of the first optical amplifier stage 100 and may include one or more optical components (e.g., a tap coupler, an isolator, a WDM, and/or a VOA), with each optical component having at least one respective integral fiber integrated therewith. The mid-section 208 may be part of the first optical amplifier stage 100 and/or part of the second optical amplifier stage 202, and may include one or more optical components (e.g., a tap coupler, an isolator, a WDM, and/or a VOA), with each optical component having at least one respective integral fiber integrated therewith. The output section 210 may be part of the second optical amplifier stage 202 and may include one or more optical components (e.g., a tap coupler, an isolator, a WDM, and/or a VOA), with each optical component having at least one respective integral fiber integrated therewith.

The optical amplifier assembly 200 may include one or more gain-flattening FBGs written into a respective fiber core of the input section 206, the first active fiber 102, the mid-section 208, the second active fiber 204, and/or the output section. For example, the optical amplifier assembly 200 may have a spectral gain profile and the one or more gain-flattening FBGs may be configured to at least partially flatten the spectral gain profile in order for the optical amplifier assembly 200 to provide an amplified signal light with an at least partially flattened spectral gain profile. For example, a gain-flattening FBG may be written into an active fiber core of the first active fiber 102, an active fiber core of the second active fiber 204, or a single-mode core of an integral fiber (e.g., an integral input pigtail or an integral output pigtail) of an optical component provided in the input section 206, the mid-section 208, or the output section 210. Moreover, multiple gain-flattening FBGs may be used at different locations of the optical amplifier assembly 200.

As indicated above, FIG. 2 is provided as an example. Other examples may differ from what is described with regard to FIG. 2.

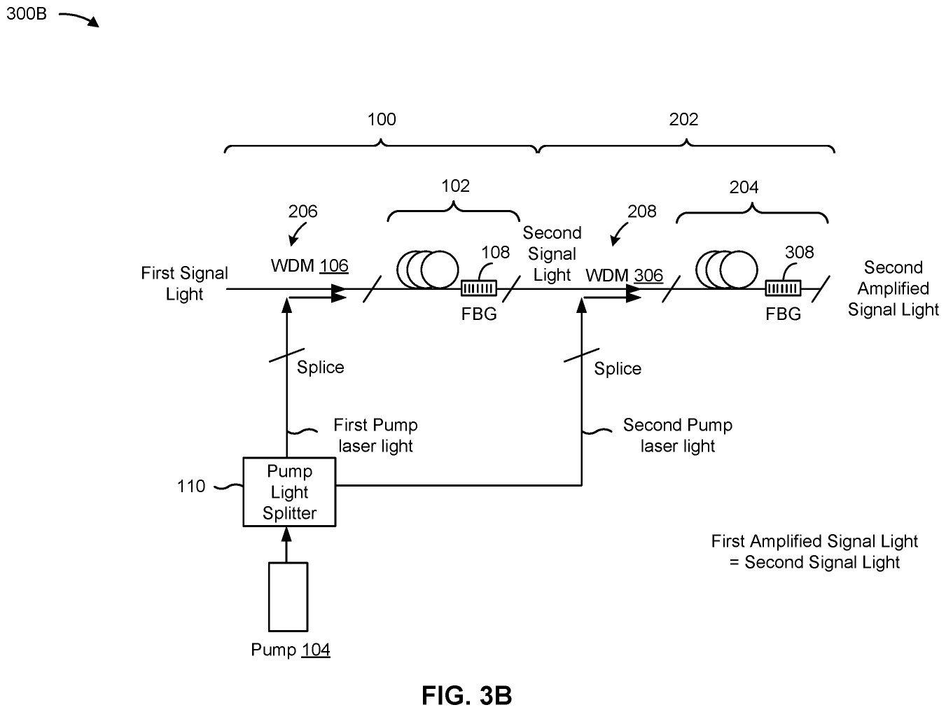

FIG. 3A shows an optical amplifier assembly 300A according to one or more implementations. The optical amplifier assembly 300A includes multiple optical amplifier stages, with each optical amplifier stage having a respective active fiber. For example, the optical amplifier assembly 200 may include the first optical amplifier stage 100 and the second optical amplifier stage 202, as described in connection with FIG. 2. In addition, the first optical amplifier stage 100 may include the input section 206, and the second optical amplifier stage 202 may include the mid-section 208. The input section 206 may include the pump laser 104 (e.g., a first pump laser 104) and the WDM coupler 106 (e.g., a first WDM coupler 106). The mid-section 208 may include a second pump laser 304 and a second WDM coupler 306.

The first active fiber core of the first active fiber 102 is configured to guide and amplify a first signal light. The first pump laser 104 is configured to provide first pump laser light. The first WDM coupler 106 is configured to couple the first pump laser light into the first active fiber core along with the first signal light. In addition, the gain-flattening FBG 108 (e.g., a first gain-flattening FBG 108) is arranged in the first active fiber core. The first optical amplifier stage 100 is configured to provide a first spectral gain profile corresponding to the first active fiber core of the first active fiber 102 and the first pump laser 104. The first gain-flattening FBG 108 may be configured to at least partially flatten the first spectral gain profile in order for the first optical amplifier stage 100 to provide a first amplified signal light with an at least partially flattened first spectral gain profile. The first amplified signal light is derived from the first signal light propagating through the first active fiber core of the first active fiber 102. The first amplified signal light may be provided to the second optical amplifier stage 202 as a second signal light.

The second active fiber core of the second active fiber 204 is configured to guide and amplify the second signal light using a second pump laser light. The second pump laser 304 is configured to provide the second pump laser light to the second WDM coupler 306, and the second WDM coupler 306 is configured to couple the second pump laser light into the second active fiber core of the second active fiber 204, along with the second signal light.

The second optical amplifier stage 202 further includes a second gain-flattening FBG 308 arranged in the second active fiber core. For example, the second gain-flattening FBG 308 may be written into the second active fiber core using a femtosecond laser. The second active fiber 204 is a single continuous fiber, and the second active fiber core is a single continuous fiber core into which the second gain-flattening FBG 308 is written.

The second optical amplifier stage 202 is configured to provide a second spectral gain profile corresponding to the second active fiber core of the second active fiber 204 and the second pump laser 304. The second gain-flattening FBG 308 may be configured to at least partially flatten the second spectral gain profile in order for the optical amplifier assembly 300A to provide a second amplified signal light with an at least partially flattened second spectral gain profile. The second amplified signal light is derived from the second signal light propagating through the second active fiber core, which may be further derived from the first signal light.

In some implementations, pump light may be coupled into an active fiber in a direction opposite to the propagation direction of the amplified signal light. For example, the second pump laser 304 and the WDM 306 could be used to couple light into the first active fiber core of the first active fiber 102 in a direction opposite to the propagation direction of the first amplified signal light. In this case, the first spectral gain profile of the first optical amplifier stage 100 may be based on the first active fiber core of the first active fiber 102, the first pump laser 104, and the second pump laser 304. In this case, an additional pump laser (not shown) may be provided for the second optical amplifier stage 202. Alternatively, the WDM 306 may be repositioned to the output of the second optical amplifier stage 202 such that the pump light from the second pump laser 304 and the WDM 306 could be used to couple light into the second active fiber core of the second active fiber 204 in a direction opposite to the propagation direction of the second amplified signal light.

In some implementations, only one of the first gain-flattening FBG 108 or the second gain-flattening FBG 308 may be present. The remaining gain-flattening FBG may be used to compensate for a net spectral gain profile of the optical amplifier assembly 300A. For example, the combination of the first spectral gain profile and the second spectral gain profile may form the net spectral gain profile (e.g., the combined spectral gain profile of the first and second amplifier stages that would be provided in the absence of the gain flattening FBG 108 and gain flattening FBG 308). The remaining gain-flattening FBG may be used to at least partially flatten the net spectral gain profile in order for the optical amplifier assembly 300A to provide the first amplified signal light and/or the second amplified signal light with an at least partially flattened spectral gain profile relative to the net spectral gain profile.

In some implementations, one or both of the first gain-flattening FBG 108 or the second gain-flattening FBG 308 may be arranged in an integral fiber of an optical component of the input section 206 or the mid-section 208. For example, in some implementations, the first gain-flattening FBG 108 may be written into an integral fiber of the first WDM coupler 106. In other words, the first gain-flattening FBG 108 may be written into a single-mode fiber core along a signal propagation path of the first signal light. For example, in some implementations, the second gain-flattening FBG 308 may be written into an integral fiber of the second WDM coupler 306. In other words, the second gain-flattening FBG 308 may be written into a single-mode fiber core along a light propagation path of the second signal light.

As one example, an optical component be provided in the input section 206 or the mid-section 208 that is coupled to the first optical amplifier stage 100. The optical component may include an integral fiber integrated with the optical component. The integral fiber may be a single-mode fiber with a single-mode fiber core that is coupled to a light propagation path of the first active fiber core of the first active fiber 102. In other words, the single-mode fiber core may be part of the light propagation path of the first active fiber core and the second active fiber core. The optical component may include a tap coupler with a photodiode coupled to the integral fiber, a WDM coupler coupled to the integral fiber, a variable optical attenuator coupled to the integral fiber, or an optical isolator coupled to the integral fiber

The optical component may include a gain-flattening FBG arranged in the single-mode fiber core. The gain-flattening FBG of the optical component may be configured to at least partially flatten the first spectral gain profile of the first optical amplifier stage 100 in order for the optical amplifier assembly 300A to provide the first amplified signal light with an at least partially flattened spectral gain profile (e.g., an at least partially flattened spectral gain profile relative the first spectral gain profile). The gain-flattening FBG of the optical component may be the first gain-flattening FBG 108 relocated from the first active fiber 102, the second gain-flattening FBG 308 relocated from the second active fiber 204, or a third gain-flattening FBG that is used in combination with the first gain-flattening FBG 108 and/or the second gain-flattening FBG 308. The optical component may be the first WDM coupler 106, the second WDM coupler 306, or another optical component (e.g., a tap coupler, an isolator, or a VOA).

In some implementations, the optical component includes a fused fiber coupler that fuses the integral fiber to an additional fiber, and the fused fiber coupler is configured as a WDM coupler or as a tap coupler. The integral fiber may be part of the light propagation path of the first active fiber core and the second active fiber core, whereas the additional fiber may be fused to the integral fiber and may be used to couple light into or out of the light propagation path. For example, the additional fiber may carry pump laser light from a pump laser to a WDM coupler. As another example, the additional fiber may be used to tap signal light out from the light propagation path and provide the tapped signal light to a photodetector.

As indicated above, FIG. 3A is provided as an example. Other examples may differ from what is described with regard to FIG. 3A.

FIG. 3B shows an optical amplifier assembly 300B according to one or more implementations. The optical amplifier assembly 300B is similar to the optical amplifier assembly 300A descried in connection with FIG. 3B, with the exception that a single pump laser (e.g., the first pump laser 104 or the second pump laser 304) may be used to pump light into both the first optical amplifier stage 100 and the second optical amplifier stage 202 instead of using two pump lasers. In other words, the first optical amplifier stage 100 and the second optical amplifier stage 202 may share the same pump source.

For example, the optical amplifier assembly 300B may include a pump light splitter 110 that is configured to receive pump light from the first pump laser 104 and split the pump light into the first pump laser light and the second pump laser light. The pump light may be split in a specific ratio, such that a first portion of the pump light (e.g., the first pump laser light) is provided to the first optical amplifier stage 100 via WDM 106 and a second portion of the pump light (e.g., the second pump laser light) is provided to the second optical amplifier stage 202 via WDM 306.

The first optical amplifier stage 100 may provide a first spectral gain profile corresponding to the first active fiber core of the first active fiber 102 and the first pump laser 104. Additionally, the second optical amplifier stage 202 may provide a second spectral gain profile corresponding to the second active fiber core of the second active fiber 204 and the first pump laser 104.

As indicated above, FIG. 3B is provided as an example. Other examples may differ from what is described with regard to FIG. 3B.

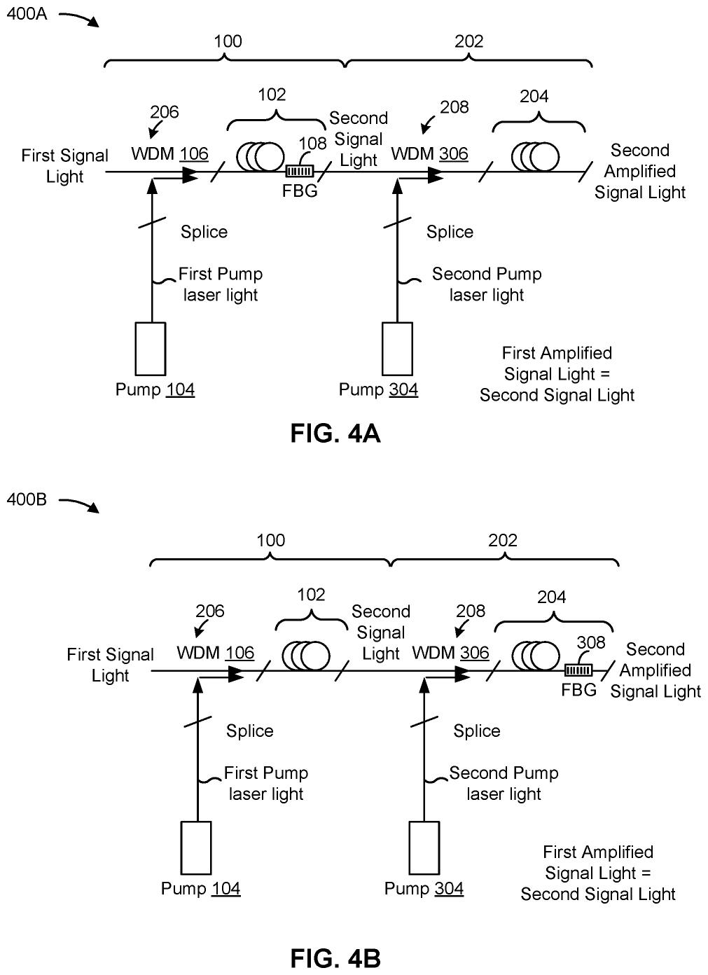

FIG. 4A shows an optical amplifier assembly 400A according to one or more implementations. The optical amplifier assembly 400A is similar to the optical amplifier assembly 300A described in connection with FIG. 3A, with the exception that the second gain-flattening FBG 308 is not present. In this example, a combination of the first spectral gain profile and the second spectral gain profile form a net spectral gain profile, and the first gain-flattening FBG 108 may be configured to at least partially flatten the net spectral gain profile in order for the optical amplifier assembly 400A to provide the first amplified signal light and/or the second amplified signal light with an at least partially flattened spectral gain profile relative to the net spectral gain profile. For example, the optical amplifier assembly 400A may be configured to provide the second amplified signal light with an at least partially flattened spectral gain profile relative to the net spectral gain profile. Thus, the first gain-flattening FBG 108 may be configured to compensate for the first spectral gain profile and for the second spectral gain profile in order for the optical amplifier assembly 400A to provide the second amplified signal light with the at least partially flattened spectral gain profile.

As indicated above, FIG. 4A is provided as an example. Other examples may differ from what is described with regard to FIG. 4A. For example, a similar configuration may be applied to the optical amplifier assembly 300B described in connection with FIG. 3B.

FIG. 4B shows an optical amplifier assembly 400B according to one or more implementations. The optical amplifier assembly 400B is similar to the optical amplifier assembly 300A described in connection with FIG. 3A, with the exception that the first gain-flattening FBG 108 is not present. In this example, a combination of the first spectral gain profile and the second spectral gain profile form a net spectral gain profile, and the second gain-flattening FBG 308 may be configured to at least partially flatten the net spectral gain profile in order for the optical amplifier assembly 400B to provide the first amplified signal light and/or the second amplified signal light with an at least partially flattened spectral gain profile relative to the net spectral gain profile. For example, the optical amplifier assembly 400B may be configured to provide the second amplified signal light with an at least partially flattened spectral gain profile relative to the net spectral gain profile. Thus, the second gain-flattening FBG 308 may be configured to compensate for the first spectral gain profile and for the second spectral gain profile in order for the optical amplifier assembly 400B to provide the second amplified signal light with the at least partially flattened spectral gain profile.

As indicated above, FIG. 4B is provided as an example. Other examples may differ from what is described with regard to FIG. 4B. For example, a similar configuration may be applied to the optical amplifier assembly 300B described in connection with FIG. 3B.

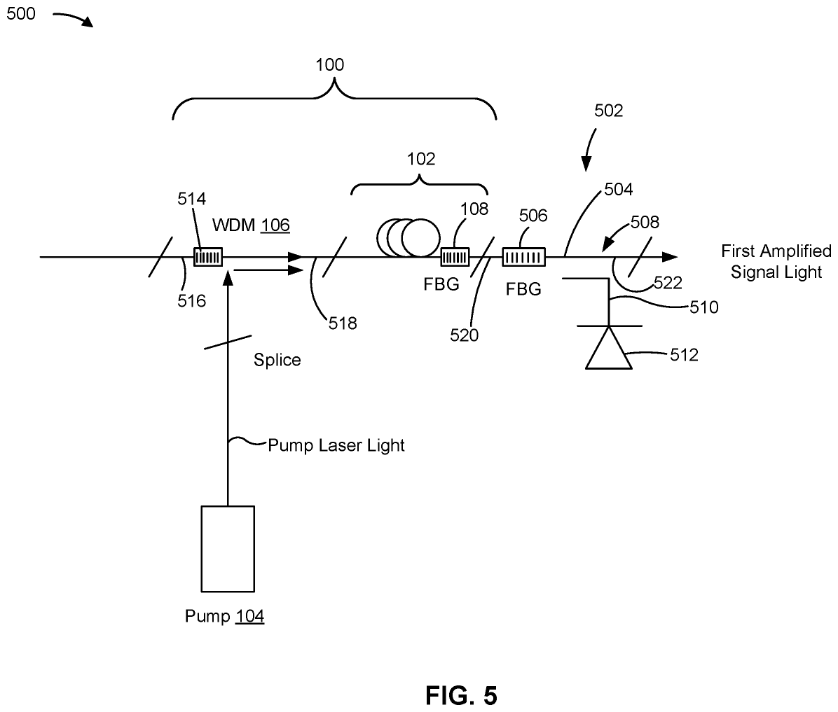

FIG. 5 shows an optical amplifier assembly 500 according to one or more implementations. The optical amplifier assembly 500 includes the first active fiber 102, the pump laser 104, and the WDM coupler 106 of the first optical amplifier stage 100. The optical amplifier assembly 500 may also include the first gain-flattening FBG 108 in the first active fiber core of the first active fiber 102. The first gain-flattening FBG 108 may be configured to at least partially flatten the first spectral gain profile of the first optical amplifier stage 100 in order for the optical amplifier assembly 500 to provide a first amplified signal light with an at least partially flattened first spectral gain profile.

In addition, the optical amplifier assembly 500 may include an optical component 502 coupled to the first optical amplifier stage 100. The optical component 502 may include an integral fiber 504 integrated with the optical component 502. The integral fiber 504 may be a single-mode fiber with a single-mode fiber core that is coupled to a light propagation path of the first active fiber core. The optical component 502 includes a gain-flattening FBG 506 arranged in the single-mode fiber core of the integral fiber 504. The gain-flattening FBG 506 may be configured to at least partially flatten the first spectral gain profile of the first optical amplifier stage 100 in order for the optical amplifier assembly 500 to provide the first amplified signal light with the at least partially flattened first spectral gain profile.

Thus, the first gain-flattening FBG 108 and the gain-flattening FBG 506 may be configured to perform a first gain-flattening function and a second gain-flattening function, respectively, that, together (e.g., in combination), are matched with the first spectral gain profile within a predetermined margin in order for the optical amplifier assembly 500 to provide the first amplified signal light with the at least partially flattened first spectral gain profile. As a result, the second gain-flattening function of the gain-flattening FBG 506 may compensate for the first spectral gain profile such that the gain-flattening FBG 506 at least partially flattens the first spectral gain profile in order to achieve the at least partially flattened first spectral gain profile. Additionally, or alternatively, the gain-flattening FBG 506 may be used to at least partially flatten a net spectral gain profile of a multi-stage optical amplifier assembly.

The optical component 502 may include a fused fiber coupler 508 that fuses the integral fiber 504 to an additional fiber 510. In this example, the fused fiber coupler is a tap coupler with a photodiode 512 coupled to the integral fiber 504 via the additional fiber 510. Additionally, or alternatively, the WDM coupler 106 may include a gain-flattening FBG 514 that performs a similar function described in connection with the gain-flattening FBG 506. Thus, the gain-flattening FBG 514 may be written into single-mode fiber core of an integral fiber 516 or 518 of the WDM coupler 106. The WDM coupler 106 may be a fused fiber coupler that is configured for wavelength-division multiplexing.

In some implementations, the gain-flattening FBG 506 may be provided without any other gain-flattening FBGs being provided. Alternatively, the gain-flattening FBG 514 may be provided without any other gain-flattening FBGs being provided. Thus, only one of the first gain-flattening FBG 108, the gain-flattening FBG 506, or the gain-flattening FBG 514 may be present for performing a gain-flattening function.

As optical components coupled to the first optical amplifier stage 100, both the optical component 502 and the WDM coupler 106 may be coupled to a respective integral input pigtail and a respective integral output pigtail that may serve as possible locations for writing a gain-flattening FBG therein.

For example, the optical amplifier assembly 500 may include an integral input pigtail 516 that is integrated with an input of an optical component (e.g., a fused fiber coupler of the WDM coupler 106). The integral input pigtail 516 may be a first single-mode fiber with a first single-mode fiber core. Additionally, the optical amplifier assembly 500 may include an integral output pigtail 518 integrated with an output of the optical component (e.g., a fused fiber coupler of the WDM coupler 106). The integral output pigtail 518 may be a second single-mode fiber with a second single-mode fiber core. The integral input pigtail 516, the optical component (e.g., a fused fiber coupler of the WDM coupler 106), and the integral output pigtail 518 may form a continuous signal path devoid of any splices. In addition, the active fiber core of the first active fiber 102, the first single-mode fiber core of the integral input pigtail 516, and the second single-mode fiber core of the integral output pigtail 518 may form a light propagation path for signal light that is amplified by the first active fiber 102. The gain-flattening FBG 514 may be arranged in the first single-mode fiber core of the integral input pigtail 516 or in the second single-mode fiber core of the integral output pigtail 518. The gain-flattening FBG 514 may be provided without any additional gain-flattening FBGs provided in the optical amplifier assembly 500. The first optical amplifier stage 100 is configured to provide a spectral gain profile corresponding to the active fiber core of the first active fiber 102 and the pump laser 104. The gain-flattening FBG 514 may be configured to at least partially flatten the spectral gain profile in order for the optical amplifier assembly 500 to provide the first amplified signal light with an at least partially flattened spectral gain profile. The first amplified signal light is derived from the signal light propagating through the active fiber core of the first active fiber 102.

Additionally, the gain-flattening FBG 506 and the gain-flattening FBG 514 may be provided without any gain-flattening FBG written into the first active fiber 102. Both the gain-flattening FBG 506 and the gain-flattening FBG 514 may be used in combination to compensate for the spectral gain profile of the first optical amplifier stage 100. The gain-flattening FBG 506 may be written into a single-mode fiber core of an integral input pigtail 520 or an integral output pigtail 522 of the optical component 502.

As indicated above, FIG. 5 is provided as an example. Other examples may differ from what is described with regard to FIG. 5.

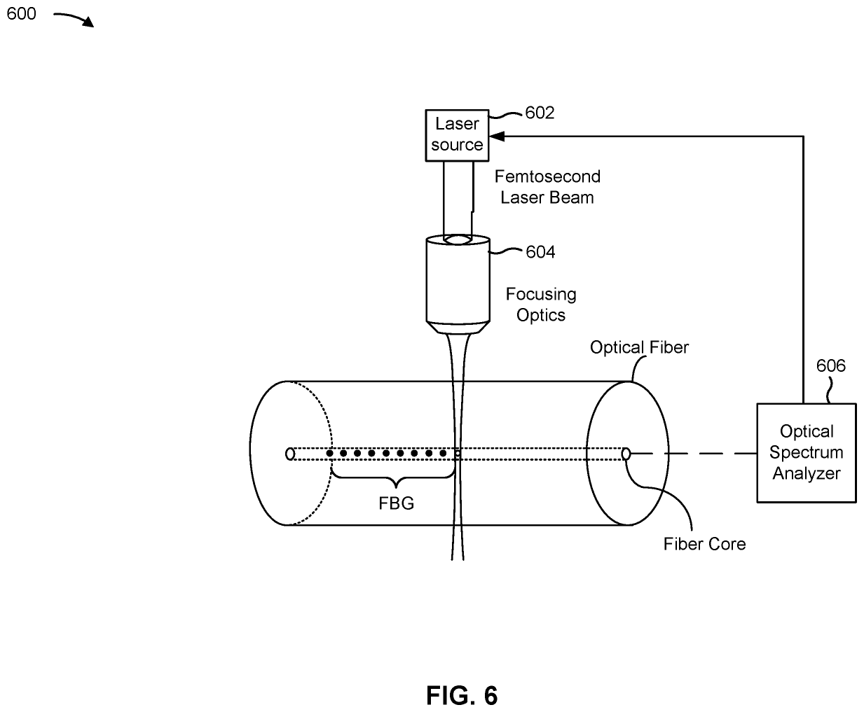

FIG. 6 shows a system 600 for writing a gain-flattening FBG into an optical fiber of an optical amplifier assembly according to one or more implementations. The system 600 may be part of an assembly system that assembles the optical amplifier assembly. The gain-flattening FBG may be written into an active fiber core of an active optical fiber or into a single-mode core of an integral fiber using a femtosecond laser. The gain-flattening FBG includes a plurality of laser-written gratings, where the plurality of laser-written gratings are configured to at least partially flatten a spectral gain profile of the optical amplifier assembly. Each of the plurality of laser-written gratings may comprise a section of the active fiber core or the single-mode fine core in which a plurality of laser written lines (e.g., a region of a core that has been exposed to the femtosecond laser light) alternates with a region of the core that has not been exposed to the femtosecond laser light. Writing the gain-flattening FBG into the active fiber core of the active optical fiber or into the single-mode core of the integral fiber may include writing the gain-flattening FBG with a laser without stripping the active optical fiber or the integral fiber, respectively.

For example, a laser source 602 may generate a femtosecond laser beam. Focusing optics 604 may provide a focused femtosecond laser beam that is directed at a fiber core to write a laser-written grating into the fiber core. One or more cameras (not explicitly illustrated) may be used to control a precise position of the focused femtosecond laser beam incident on the fiber core. Multiple laser-written gratings may be written into the fiber core to achieve a desired gain-flattening function of the gain-flattening FBG. A spectral gain analyzer 606, such as an optical spectrum analyzer, may be used to measure a spectral gain profile of an optical amplifier stage or of the optical amplifier assembly as a whole. The measured spectral gain profile may be used for controlling a design of the gain-flattening FBG and a writing of the gain-flattening FBG into the fiber core. In particular, the measured spectral gain profile may be used as feedback information for writing the gain-flattening FBG in order to achieve a desired gain-flattened spectral profile within a predetermined margin. In some implementations, the spectral gain analyzer 606 may include at least one processor and/or controller configured to perform one or more measurements of the spectral gain profile, perform a comparison of a measured spectral gain profile with the desired gain-flattened spectral profile, and control the writing of the gain-flattening FBG based on a result of the comparison.

As indicated above, FIG. 6 is provided as an example. Other examples may differ from what is described with regard to FIG. 6.

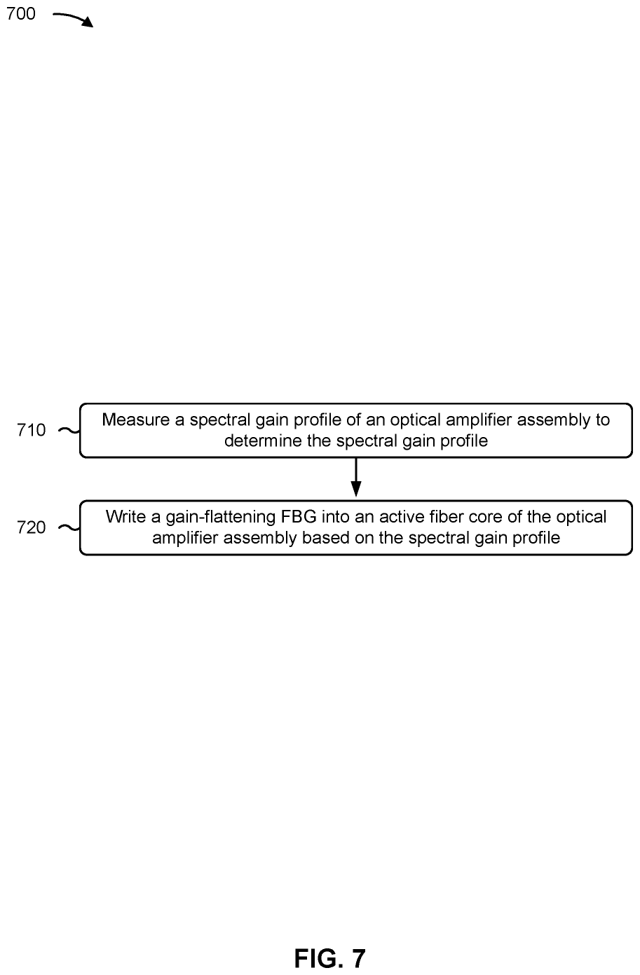

FIG. 7 is a flowchart of an example process 700 associated with a method of writing a gain-flattening FBG into an active optical fiber of an optical amplifier assembly. The active optical fiber includes an active fiber core configured as a gain medium that contributes to a spectral gain profile of the optical amplifier assembly. In some implementations, one or more process blocks of FIG. 7 are performed by a system (e.g., system 600). In some implementations, one or more process blocks of FIG. 7 are performed by another device or a group of devices separate from or including the system 600. Additionally, or alternatively, one or more process blocks of FIG. 7 may be performed to generate one or more gain-flattening FBGs described in connection with FIGS. 1-6.

As shown in FIG. 7, process 700 may include measuring the spectral gain profile of the optical amplifier assembly to determine the spectral gain profile optical amplifier assembly (block 710). For example, the spectral gain analyzer 606 device may measure the spectral gain profile of the optical amplifier assembly to determine the spectral gain profile, as described above.

As further shown in FIG. 7, process 700 may include writing the gain-flattening FBG into the active fiber core based on the spectral gain profile (block 720). The gain-flattening FBG may be written into the active fiber core to provide a gain-flattening function that compensates for the spectral gain profile such that the gain-flattening FBG at least partially flattens the spectral gain profile in order to achieve a desired gain-flattened spectral profile within a predetermined margin. For example, the system 600 may write the gain-flattening FBG into the active fiber core, as described above.

Writing the gain-flattening FBG may include iteratively writing one or more FBG segments to form the gain-flattening FBG. Each FBG segment includes one or more grating lines. Measuring the spectral gain profile of the optical amplifier assembly may include iteratively measuring the spectral gain profile after each FBG segment of the gain-flattening FBG is written into the active fiber core, comparing each measurement of the spectral gain profile to the desired gain-flattened spectral profile, writing an additional FBG segment of the gain-flattening FBG into the active fiber core if the spectral gain profile does not match the desired gain-flattened spectral profile within the predetermined margin, and stop writing the gain-flattening FBG into the active fiber core if the spectral gain profile matches the gain-flattened spectral profile within the predetermined margin.

For example, the system 600 (e.g., the spectral gain analyzer 606) may determine after each measurement of the spectral gain profile whether the gain-flattening FBG has been sufficiently written to obtain a desired gain-flattened spectral profile within a predetermined margin (e.g., within a predetermined margin of the desired gain-flattened spectral profile). If the measured spectral gain profile is within the predetermined margin of the desired gain-flattened spectral profile, the system 600 may determine that the writing of the gain-flattening FBG is complete and may stop writing further FBG segments. Alternatively, if the system 600 determines that the measured spectral gain profile is not within the predetermined margin of the desired gain-flattened spectral profile, the system 600 may write the next FBG segment of the gain-flattening FBG, remeasure the spectral gain profile of the optical amplifier assembly, and compare the remeasured spectral gain profile to the desired gain-flattened spectral profile to determine if the remeasured spectral gain profile is within the predetermined margin of the desired gain-flattened spectral profile. Based on the comparison, the system 600 may determine whether to stop writing the gain-flattening FBG or to write a next FBG segment of the gain-flattening FBG.

Process 700 may include additional implementations, such as any single implementation or any combination of implementations described below and/or in connection with one or more other processes described elsewhere herein.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

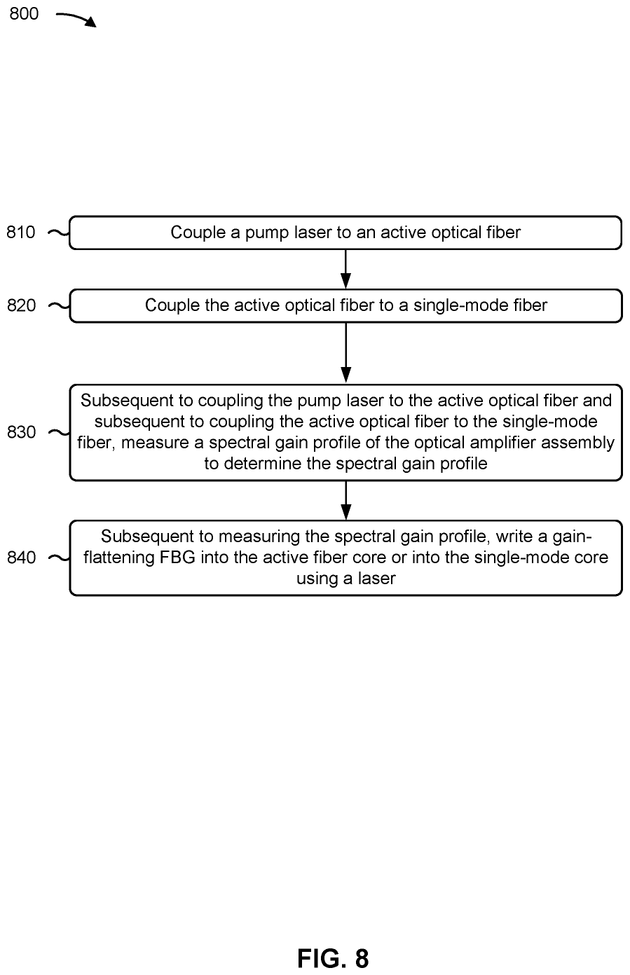

FIG. 8 is a flowchart of an example process 800 associated with a method of writing a gain-flattening FBG into an optical amplifier assembly. In some implementations, one or more process blocks of FIG. 8 are performed by an assembly system (e.g., system 600). In some implementations, one or more process blocks of FIG. 8 are performed by another device or a group of devices separate from or including the system 600. Additionally, or alternatively, one or more process blocks of FIG. 8 may be performed to generate one or more gain-flattening FBGs described in connection with FIGS. 1-6.

As shown in FIG. 8, process 800 may include coupling a pump laser to an active optical fiber, wherein the active optical fiber includes an active fiber core configured as a gain medium that contributes to a spectral gain profile of the optical amplifier assembly (block 810). For example, the assembly system may couple the pump laser 104 to the active fiber 102, as described above.

As further shown in FIG. 8, process 800 may include coupling the active optical fiber to a single-mode fiber (block 820). The single-mode fiber includes a single-mode core that forms a propagation path with the active fiber core for signal light. The single-mode fiber may be an integral fiber (e.g., a pigtail) that is integrated with an optical component of the optical amplifier assembly. For example, the assembly system may couple the active optical fiber to the single-mode fiber, as described above.

As further shown in FIG. 8, process 800 may include, subsequent to coupling the pump laser to the active optical fiber and subsequent to coupling the active optical fiber to the single-mode fiber, measuring the spectral gain profile of the optical amplifier assembly to determine the spectral gain profile (block 830). For example, the assembly system may, subsequent to coupling the pump laser 104 to the active fiber 102 and subsequent to coupling the active fiber 102 to the single-mode fiber of the integral output pigtail 518 and/or to the single-mode fiber of the integral input pigtail 520, measure the spectral gain profile of the optical amplifier assembly to determine the spectral gain profile, as described above.

As further shown in FIG. 8, process 800 may include, subsequent to measuring the spectral gain profile, writing the gain-flattening FBG into the active fiber core or into the single-mode core using a laser (block 840). The gain-flattening FBG is written into the active fiber core or into the single-mode core to provide a gain-flattening function that compensates for the spectral gain profile of the optical amplifier such that the gain-flattening FBG at least partially flattens the spectral gain profile in order to achieve a desired gain-flattened spectral profile. For example, the assembly system may, subsequent to measuring the spectral gain profile, write the gain-flattening FBG into the active fiber core or into the single-mode core using a laser, as described above.

In some implementations, blocks 830 and 840 may be iteratively performed multiple times. For example, measuring the spectral gain profile and writing the gain-flattening FBG may include writing one or more FBG segments to form the gain-flattening FBG by iteratively measuring the spectral gain profile after each FBG segment of the gain-flattening FBG is written, comparing each measurement of the spectral gain profile to the desired gain-flattened spectral profile, writing an additional FBG segment of the gain-flattening FBG if the spectral gain profile does not match the desired gain-flattened spectral profile within the predetermined margin, and stop writing the gain-flattening FBG if the spectral gain profile matches the gain-flattened spectral profile within the predetermined margin.

Process 800 may include additional implementations, such as any single implementation or any combination of implementations described below and/or in connection with one or more other processes described elsewhere herein.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

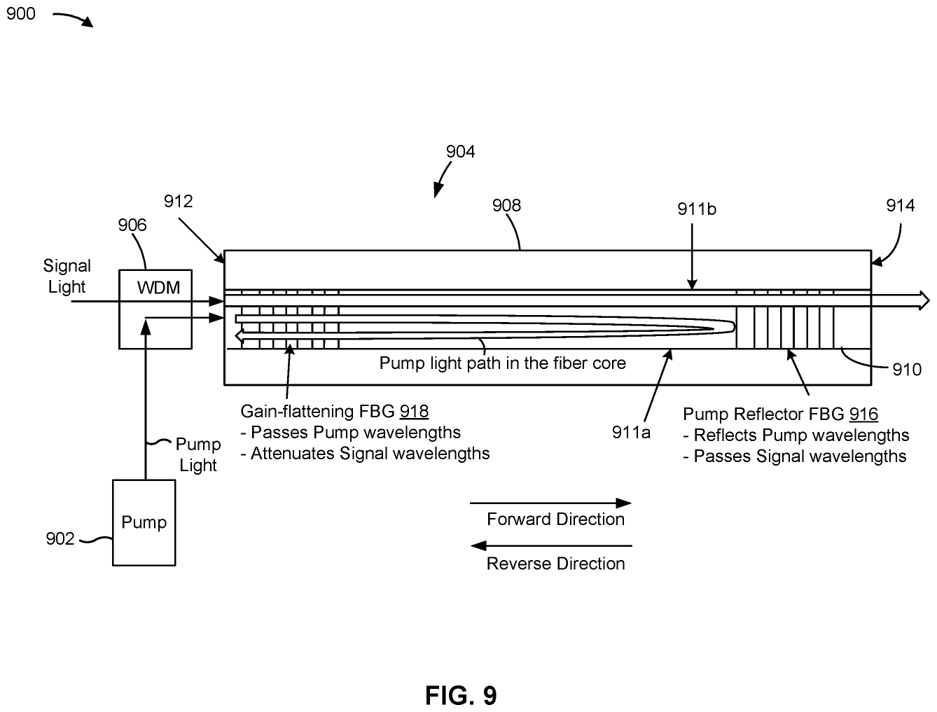

FIG. 9 shows an optical amplifier assembly 900 according to one or more implementations. The optical amplifier assembly 900 may include a pump source 902, optical amplifier 904, and a combiner 906. The pump source 902 may be a pump laser (e.g., pump laser 104) configured to generate a pump light. The optical amplifier 904 may include an active fiber 908 having a fiber core 910 configured as a gain medium that is configured to guide and amplify a signal light. A cross-section of the active fiber 908, including its fiber core 910, is illustrated in FIG. 9. Accordingly, a cross-section of a diameter of the fiber core 910 is defined by a first edge 911a and a second edge 911b. The combiner 906 is configured to couple the signal light and the pump light into the fiber core 910. The pump light is configured to amplify the signal light. In some implementations, the combiner 906 may be a WDM coupler (e.g., WDM coupler 106). The fiber core 910 is configured to guide the signal light in a forward direction from an input end 912 of the active fiber 908 to an output end 914 of the active fiber 908. In addition, the fiber core 910 is configured to guide the pump light in the forward direction from the input end 912 of the active fiber 908 toward the output end 914 of the active fiber 908. The fiber core 910 is doped with an active dopant configured to absorb a portion of the pump light to generate additional signal light. The additional signal light may have a same wavelength or wavelength band as the signal light received at an input of the combiner 906.

The optical amplifier assembly 900 further includes a pump reflector FBG 916 written into the fiber core 910 of the active fiber 908. For example, the pump reflector FBG 916 may be laser-written into the fiber core 910 using a femtosecond laser. The pump reflector FBG 916 is configured to reflect a remaining portion of the pump light in a reverse direction for absorption by the active dopant. That is, not all pump light may be absorbed by the active dopant (e.g., the first instance); the pump light is transmitted from the input end 912 to the pump reflector FBG 916, leaving a remaining portion of unabsorbed pump light at the pump reflector FBG 916 pump reflector FBG 916. The pump reflector FBG 916 is configured to allow wavelengths of the signal light and wavelengths of the additional signal light to pass through the pump reflector FBG 916, unattenuated, to an output of the active fiber 908, and reflect wavelengths of the pump light toward the input end 912 of the active fiber 908. As a result, at least a portion of the remaining portion of unabsorbed pump light may be absorbed by the active dopants and converted into additional signal light to further amplify the signal light and improve the efficiency of the optical amplifier 904. The pump reflector FBG 916 may be written at the output end 914 of the active fiber 908 to maximize the absorption of pump light by the active dopants.

In some implementations, the active fiber 908 may include a gain-flattening FBG 918 written into the fiber core 910 at the input end 912 of the active fiber 908. Alternatively, the gain-flattening FBG 918 may be written into the fiber core 910 at another position along the length of the fiber 908. The gain-flattening FBG 918 may be similar to other gain-flattening FBGs described above. For example, the gain-flattening FBG 918 may be configured to at least partially flatten a spectral gain profile of the optical amplifier assembly 900 in order for the optical amplifier assembly 900 to provide an amplified signal light with an at least partially flattened spectral gain profile, as described above.

As indicated above, FIG. 9 is provided as an example. Other examples may differ from what is described with regard to FIG. 9.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical amplifier assembly, comprising:
a first optical amplifier stage comprising:
a first active fiber with a first active fiber core configured to guide and amplify a first signal light;
a first pump laser configured to provide first pump laser light;
a first wavelength-division multiplexing (WDM) coupler configured to couple the first pump laser light into the first active fiber core; and
a first gain-flattening fiber Bragg grating (FBG) arranged in the first active fiber core,
wherein the first optical amplifier stage is configured to provide a first spectral gain profile corresponding to the first active fiber core and the first pump laser,
wherein the first gain-flattening FBG is configured to at least partially flatten the first spectral gain profile in order for the optical amplifier assembly to provide a first amplified signal light with an at least partially flattened first spectral gain profile, and
wherein the first amplified signal light is derived from the first signal light propagating through the first active fiber core.

2. The optical amplifier assembly of claim 1, wherein the first gain-flattening FBG is configured to provide the first amplified signal light with the at least partially flattened first spectral gain profile.

3. The optical amplifier assembly of claim 1, wherein the first gain-flattening FBG is configured to substantially or completely flatten the first spectral gain profile in order for the optical amplifier assembly to provide the first amplified signal light with the at least partially flattened first spectral gain profile.

4. The optical amplifier assembly of claim 1, wherein the first gain-flattening FBG is configured to perform a first gain-flattening function that is matched with the first spectral gain profile within a predetermined margin in order for the optical amplifier assembly to provide the first amplified signal light with the at least partially flattened first spectral gain profile.

5. The optical amplifier assembly of claim 1, wherein the first gain-flattening FBG is configured to perform a first gain-flattening function that compensates for the first spectral gain profile such that the gain-flattening FBG at least partially flattens the first spectral gain profile in order to achieve the at least partially flattened first spectral gain profile.

6. The optical amplifier assembly of claim 1, wherein the first active fiber is a single continuous fiber, and
wherein the first active fiber core is a single continuous fiber core into which the first gain-flattening FBG is written.

7. The optical amplifier assembly of claim 1, further comprising:
a second optical amplifier stage coupled to the first optical amplifier stage, wherein the second optical amplifier stage comprises:
a second active fiber with a second active fiber core configured to guide and amplify a second signal light, wherein the second active fiber core is coupled to the first active fiber core;
a second pump laser configured to provide second pump laser light;
a second WDM coupler configured to couple the second pump laser light into the second active fiber core; and
a second gain-flattening FBG arranged in the second active fiber core,
wherein the second optical amplifier stage is configured to provide a second spectral gain profile corresponding to the second active fiber core and the second pump laser,
wherein the second gain-flattening FBG is configured to at least partially flatten the second spectral gain profile in order for the optical amplifier assembly to provide a second amplified signal light with an at least partially flattened second spectral gain profile, and
wherein the second amplified signal light is derived from the second signal light propagating through the second active fiber core.

8. The optical amplifier assembly of claim 7, wherein the first optical amplifier stage is configured to provide the first amplified signal light as the second signal light to the second optical amplifier stage.

9. The optical amplifier assembly of claim 7, wherein the second signal light is derived from the first amplified signal light.

10. The optical amplifier assembly of claim 1, further comprising:
a second optical amplifier stage coupled to the first optical amplifier stage, wherein the second optical amplifier stage comprises:
a second active fiber with a second active fiber core configured to guide and amplify a second signal light, wherein the second active fiber core is coupled to the first active fiber core;
a second pump laser configured to provide second pump laser light; and
a second WDM coupler configured to couple the second pump laser light into the second active fiber core; and
wherein the second optical amplifier stage is configured to provide a second spectral gain profile corresponding to the second active fiber core and the second pump laser,
wherein a combination of the first spectral gain profile and the second spectral gain profile form a net spectral gain profile,
wherein the first gain-flattening FBG is configured to at least partially flatten the net spectral gain profile in order for the optical amplifier assembly to provide the first amplified signal light with the at least partially flattened first spectral gain profile.

11. The optical amplifier assembly of claim 10, wherein the first gain-flattening FBG is configured to compensate for the first spectral gain profile and for the second spectral gain profile in order for the optical amplifier assembly to provide the first amplified signal light with the at least partially flattened first spectral gain profile.

12. The optical amplifier assembly of claim 1, further comprising:
an optical component coupled to the first optical amplifier stage, wherein the optical component comprises an integral fiber integrated with the optical component, wherein the integral fiber is a single-mode fiber with a single-mode fiber core,
wherein the single-mode fiber core is coupled to a light propagation path of the first active fiber core,
wherein the optical component comprises a second gain-flattening FBG arranged in the single-mode fiber core,
wherein the second gain-flattening FBG is configured to at least partially flatten the first spectral gain profile in order for the optical amplifier assembly to provide the first amplified signal light with the at least partially flattened first spectral gain profile.

13. The optical amplifier assembly of claim 12, wherein the optical component includes a fused fiber coupler that fuses the integral fiber to an additional fiber, and
wherein the fused fiber coupler is configured as a wavelength-division multiplexing coupler or as a tap coupler.

14. The optical amplifier assembly of claim 12, wherein the optical component includes a tap coupler with a photodiode coupled to the integral fiber, a WDM coupler coupled to the integral fiber, a variable optical attenuator coupled to the integral fiber, or an optical isolator coupled to the integral fiber.

15. The optical amplifier assembly of claim 1, further comprising:
a pump light splitter configured to receive pump light from the first pump laser and split the pump light into the first pump laser light and a second pump laser light;
a second optical amplifier stage coupled to the first optical amplifier stage, wherein the second optical amplifier stage comprises:
a second active fiber with a second active fiber core configured to guide and amplify a second signal light, wherein the second active fiber core is coupled to the first active fiber core;
a second WDM coupler configured to couple the second pump laser light into the second active fiber core; and
a second gain-flattening FBG arranged in the second active fiber core,
wherein the second optical amplifier stage is configured to provide a second spectral gain profile corresponding to the second active fiber core and the first pump laser,
wherein the second gain-flattening FBG is configured to at least partially flatten the second spectral gain profile in order for the optical amplifier assembly to provide a second amplified signal light with an at least partially flattened second spectral gain profile, and
wherein the second amplified signal light is derived from the second signal light propagating through the second active fiber core.

16. An optical amplifier assembly, comprising:
an optical amplifier stage comprising:
an active fiber with an active fiber core configured to guide and amplify a signal light;
a pump laser configured to provide pump laser light; and
a wavelength-division multiplexing (WDM) coupler configured to couple the pump laser light into the active fiber core;
an optical component coupled to the optical amplifier stage;
an integral input pigtail integrated with an input of the optical component, wherein the integral input pigtail is a first single-mode fiber with a first single-mode fiber core; and
an integral output pigtail integrated with an output of the optical component, wherein the integral output pigtail is a second single-mode fiber with a second single-mode fiber core,
wherein the integral input pigtail, the optical component, and the integral output pigtail form a continuous signal path devoid of any splices,
wherein the active fiber core, the first single-mode fiber core, and second single-mode fiber core form a light propagation path,
wherein the optical component comprises a gain-flattening FBG arranged in the first single-mode fiber core or in the second single-mode fiber core,
wherein the optical amplifier stage is configured to provide a spectral gain profile corresponding to the active fiber core and the pump laser,
wherein the gain-flattening FBG is configured to at least partially flatten the spectral gain profile in order for the optical amplifier assembly to provide an amplified signal light with an at least partially flattened spectral gain profile, and
wherein the amplified signal light is derived from the signal light propagating through the active fiber core.

17. A method of writing a gain-flattening fiber Bragg grating (FBG) into an active optical fiber of an optical amplifier assembly, wherein the active optical fiber includes an active fiber core configured as a gain medium that contributes to a spectral gain profile of the optical amplifier assembly, the method comprising:
measuring the spectral gain profile of the optical amplifier assembly to determine the spectral gain profile; and
writing the gain-flattening FBG into the active fiber core, wherein the gain-flattening FBG is written into the active fiber core to provide a gain-flattening function that compensates for the spectral gain profile such that the gain-flattening FBG at least partially flattens the spectral gain profile in order to achieve a desired gain-flattened spectral profile within a predetermined margin.

18. The method of claim 17, wherein writing the gain-flattening FBG includes iteratively writing one or more FBG segments to form the gain-flattening FBG, wherein each FBG segment includes one or more grating lines,
wherein measuring the spectral gain profile of the optical amplifier assembly includes iteratively measuring the spectral gain profile after each FBG segment of the gain-flattening FBG is written into the active fiber core, comparing each measurement of the spectral gain profile to the desired gain-flattened spectral profile, writing an additional FBG segment of the gain-flattening FBG into the active fiber core if the spectral gain profile does not match the desired gain-flattened spectral profile within the predetermined margin, and stop writing the gain-flattening FBG into the active fiber core if the spectral gain profile matches the gain-flattened spectral profile within the predetermined margin.

19. The method of claim 17, wherein the gain-flattening FBG includes a plurality of laser-written gratings, wherein the plurality of laser-written gratings are configured to at least partially flatten the spectral gain profile.

20. The method of claim 17, wherein writing the gain-flattening FBG into the active fiber core includes using a femtosecond laser to write the gain-flattening FBG into the active fiber core.

21. The method of claim 17, wherein writing the gain-flattening FBG into the active fiber core includes writing the gain-flattening FBG into the active fiber core with a laser without stripping the active optical fiber.

22. A method of writing a gain-flattening fiber Bragg grating (FBG) into an optical amplifier assembly, the method comprising:
coupling a pump laser to an active optical fiber, wherein the active optical fiber includes an active fiber core configured as a gain medium that contributes to a spectral gain profile of the optical amplifier assembly;
coupling the active optical fiber to a single-mode fiber, wherein the single-mode fiber includes a single-mode core that forms a propagation path with the active fiber core for signal light;
subsequent to coupling the pump laser to the active optical fiber and subsequent to coupling the active optical fiber to the single-mode fiber, measuring the spectral gain profile of the optical amplifier assembly to determine the spectral gain profile; and
subsequent to measuring the spectral gain profile, writing the gain-flattening FBG into the active fiber core or into the single-mode core using a laser, wherein the gain-flattening FBG is written into the active fiber core or into the single-mode core to provide a gain-flattening function that compensates for the spectral gain profile such that the gain-flattening FBG at least partially flattens the spectral gain profile in order to achieve a desired gain-flattened spectral profile.
